(19) United States
(12) Patent Application Publication
(10) Pub. No.: US 2007/0193122 A1
(43) Pub. Date: Aug. 23, 2007

(54) Roof tarp

(76) Inventors: Antonio Diaz, Miami Lakes, FL (US); Ernesto Alonso, Hialeah, FL (US)

Correspondence Address: RUBEN ALCOBA, ESQ., 3399 NW 72 AVENUE, SUITE211, MIAMI, FL, 33122, US

(21) Appl. No.: 11/373,448

(22) Filed: Mar. 11, 2006

Related U.S. Application Data
(63) Continuation-in-part of application No. 11/339,877, filed on Jan. 26, 2006.

(51) Int. Cl. B62D 63/04; E04B 1/34

(52) U.S. Cl. 52/3

(57) ABSTRACT

The present invention is a roof tarp. The roof tarp is a square or rectangular shaped tarp that has a first and a second face. The tarp has a strip that runs parallel and abuts all edges of the tarp, the strip is at-least two and a half inches in width from each edge of the tarp and is at-least a sixteenth of an inch in height from the first face of the tarp. A covering overlaps the strip. In another variation of the invention, a grommet is attached to each corner of the tarp, and a lifting means attaches to the grommet.

### CROSS REFERENCES

The present application is a continuation in part of our application Ser. No. 11/339,877 filed Jan. 26, 2006, entitled “ROOF TARP,” currently pending (attorney docket number 10041). The application incorporated herein by this reference is not admitted to be prior art with respect to the present invention by its mention in the background.

### BACKGROUND

During the Hurricane season of 2005, the inventors realized that there was a need to provide homeowners with a better way of dealing with wind damaged roofs. During the season, homeowners who had damaged roofs contacted contract roofers to place blue tarps on their roofs. As was carefully noted on television, roofers were overcharging the government and homeowners when placing blue tarps on wind damaged roofs. It was also noted that only flat/shingle roofs could be protected by blue tarps. In other words, if you had a barrel tile roof, you were out of luck.

The inventors realized that there had to be a way of providing home owners with a cost effective tarp that would easily be applied to ones roof, regardless of the roof type. They further realized that materials were hard to find after natural emergencies. The inventors therefore invented a tarp that could easily be applied to ones roof with out the need of contracting a roofer.

The customary way of applying blue tarps to wind damaged roofs is known in the art. The materials needed are nails, sand bags, blue tarps, and wood strips. The method of patching a damaged roof is by first placing a blue tarp over the wind damaged part of the roof. Then, the blue tarp is secured to the roof. Lastly, wood strips are placed to run perpendicular to the horizontal axis of the roof and then nailed to the roof. As can be seen by the method, under normal circumstances, the method of patching a roof is beyond the scope of a normal homeowner.

An object of this invention is to it eliminate the need of using contractors to place an emergency tarp on a wind damaged roof.

Another object of this invention is to minimize the costs incurred when temporarily patching a roof.

Yet another object of this invention is to minimize the elements needed to temporarily patch a roof.

A further object of this invention is to provide a tarp that can easily be lifted upon a damaged roof.

Another object of this invention is to minimize the damage incurred when placing a tarp on a damaged roof.

Yet another object of this invention is to provide a tarp that can be applied to a barrel tile roof.

### SUMMARY

The present invention is a roof tarp. The tarp eliminates the need of using nails, sandbags, and wood strips to a wind damaged roof. This makes the tarp user friendly to most homeowners, for they do not have to lift un-needed elements onto a roof. The roof tarp further allows homeowners to patch barrel type roofs.

The roof tarp is a square or rectangular shaped tarp that has a first and a second face. The tarp has a strip that runs parallel and abuts all edges of the tarp, the tar strip is at-least two and a half inches in width from each edge of the tarp and is at-least a sixteenth of an inch in height from the first face of the tarp. A covering covers the tar strip. In a further embodiment of this invention, a grommet is attached to each corner of the tarp, and a lifting means is attached to the grommets.

The roof tarp is used by placing the tarp's first face over the damaged roof, then removing the covering from the strip, then applying pressure to the second face of the tarp at locations immediately above the strip so that the strip adheres to the roof.

The inventors, when testing their previous invention, discovered that the tarp described above could accomplish the same results as their previous invention. They further realized that the above tarp withstands up to forty-mile an hour winds on a roof.

### DRAWINGS

These and other features, aspects, and advantages of the present invention will become better understood with regard to the following description, appended claims, and drawings where:

FIG. 1a shows a roof tarp on a barrel type damaged roof;

FIG. 1b shows the roof tarp on a shingle type damaged roof;

FIG. 2 is a side view of the roof tarp applied on a barrel type roof;

FIG. 3 is a side view of the roof tarp wherein the placement of the tar strip and the covering are shown;

FIGS. 4a-4b shows both faces of the roof tarp;

FIG. 5 shows a plurality of tarps being attached and aligned together;

FIG. 6a-6b shows a method of folding the roof tarp so that all grommets are aligned together;

FIG. 6c shows a rope being attached to the grommets of the roof tarp; and

FIG. 6d shows a homeowner lifting a roof tarp onto a roof.

### DESCRIPTION

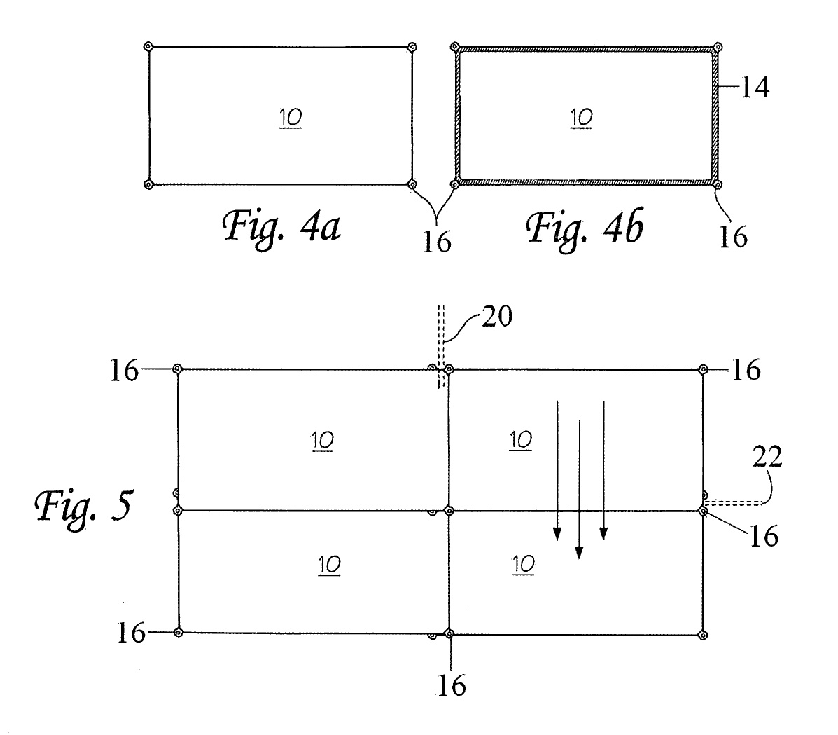

As shown in FIGS. 3-4b, a roof tarp comprises a square or rectangular shaped tarp 10 having a first and a second face, a strip 12 that runs parallel and abuts all edges of the tarp 10, the strip 12 is at-least two and a half inches in width from each edge of the tarp 10 and is at-least a sixteenth of an inch in height from the first face of the tarp10, a covering 14 attached and covering the strip 12. The tarp can be made of any material known in the art used to cover damaged roofs, for example, poly tarpaulin. The strip can either be made of tar or self-adhering membranes. The covering can either be made of cellophane or of a paper backing material.

In yet a further embodiment of the invention above, as seen in FIGS. 4a-6c, the tarp 10 further comprises of four grommets 16, wherein each grommet 16 is attached to the tarp 10 at each corner of the tarp 10, and a lifting means 18 attached to the grommets 16. The lifting means 18 might be a rope or a cable. Each Grommet 16 is reinforced to be able to hold the weight of the tarp 10 without ripping from the tarp 10.

A method of using the tarp 10 described above which comprising the steps of first lifting the tarp 10 on to a damaged roof, then placing the first face of the tarp over the damaged roof, next removing the covering 14 from the strip 12, and lastly applying pressure to the second face of the tarp 10 at a location immediately above the strip 12 so that the strip 14 adheres to the roof.

As seen in FIG. 5, the inventors have further invented a method of using at-least two of the roof tarps described above in conjunction with each other to cover a larger area of a damaged roof. The method of using at-least two roof tarps described above comprises the steps of lifting two tarps 10 on to a damaged roof, aligning the first face of the first tarp 10 with the second face of the second tarp 10 so that the edge of the second tarp 10 overlaps the first tarp 10, the tarps 10 being linearly aligned 20/22, removing the covering from the second tarp 10 and applying pressure to the second tarp 10 so that the first and the second tarps 10 are attached together, then placing the first faces of the tarps 10 over the damaged roof, removing the coverings 14 from the strips 12, and applying pressure to the second faces of the tarps 10 at locations immediately above the strips 12 so that the strips 12 adheres to the roof.

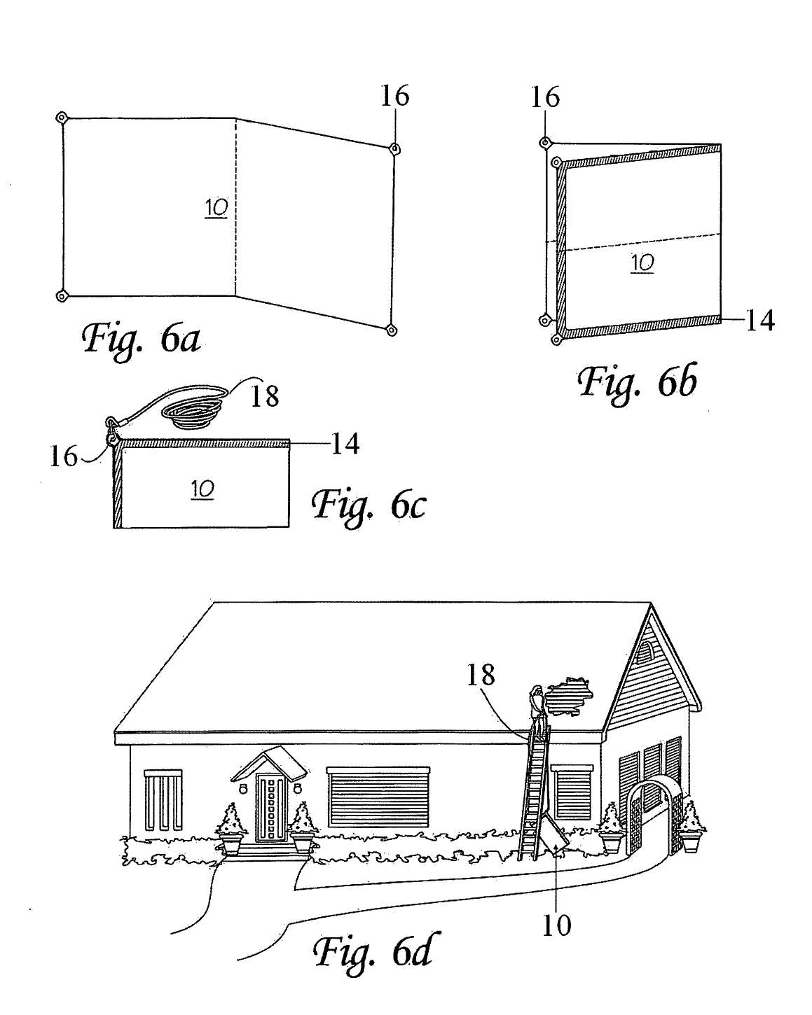

As seen in FIGS. 6a-6c, the tarp 10 is folded together prior to lifting the tarp onto a roof. Upon the tarp 10 being folded so that all grommets 16 are overlapping each other, a lifting means 18 is attached to the grommets 16. FIG. 6c shows a homeowner lifting the tarp 10 onto a roof.

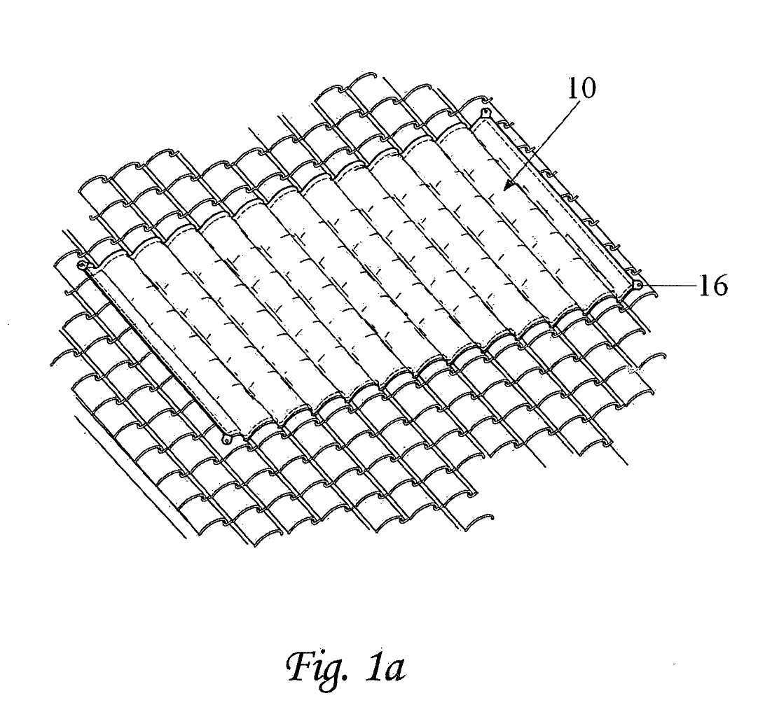

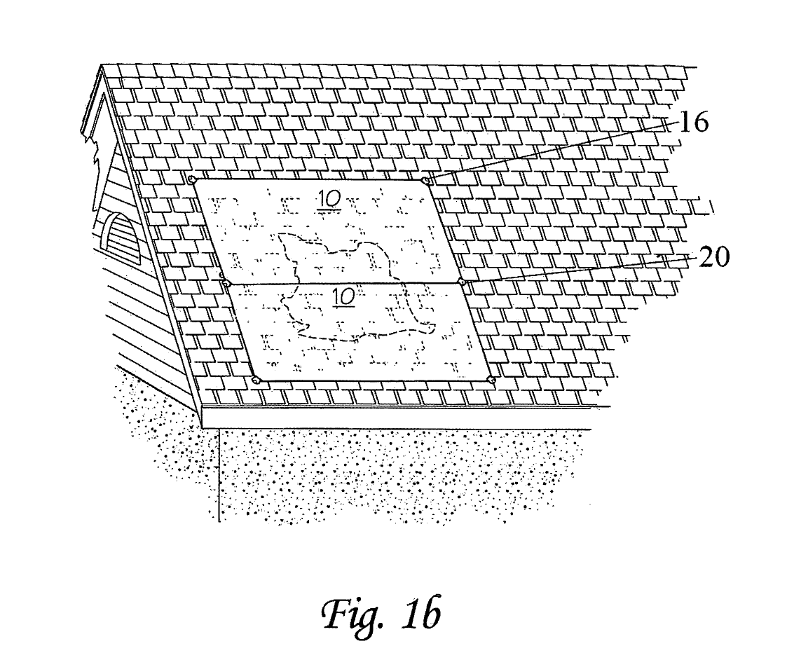

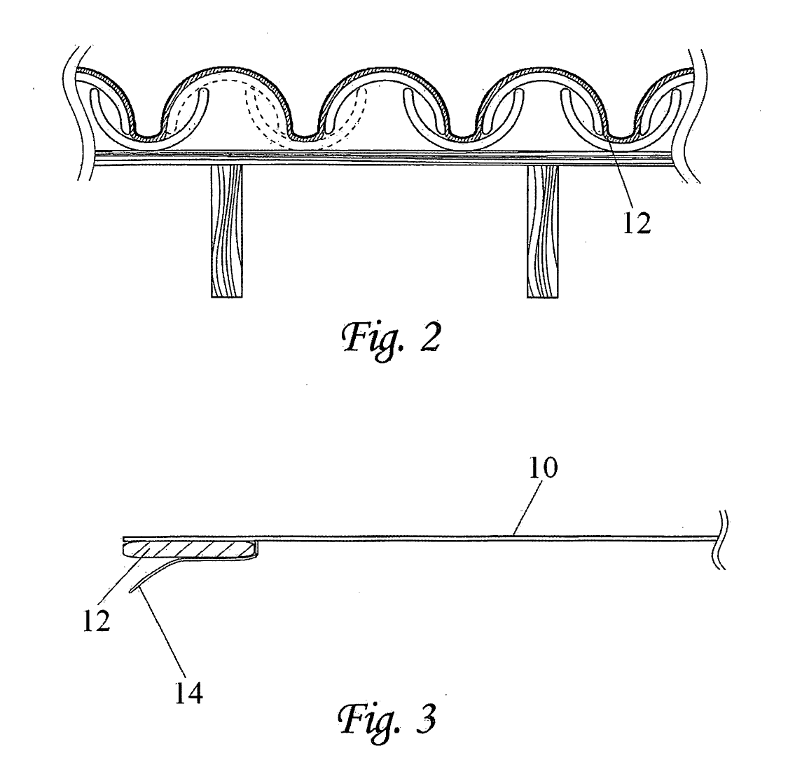

As seen in FIGS. 1a-b, the roof tarp can be used on either shingle roofs or barrel tile roofs.

An advantage of this invention is that it eliminates the need of using a contractor/roofer to place emergency tarp over a wind damaged roof.

Another advantage of this invention is that it is a cost effective way of temporarily patching a damaged roof.

Yet another advantage of this invention is that it minimizes the elements needed to temporarily patch a roof.

A further advantage of this invention is that it can easily be lifted onto a damaged roof.

Another advantage of this invention is that it minimizes the damage to ones roof when securing the tarp to the damaged roof.

Yet another advantage of this invention is that it can be applied to a barrel tile roof.

Although the present invention has been described in considerable detail with reference to certain preferred versions thereof, other versions are possible. Therefore the spirit and the scope of the claims should not be limited to the description of the preferred versions contained herein.

1. A roof tarp comprising:
a square or rectangular shaped tarp having a first and a second face;
a strip that runs parallel and abuts all edges of the tarp, the strip is at-least two and a half inches in width from each He of the tarp and is at-least a sixteenth of an inch in height from the first face of the tarp; and
a covering attached and covering the strip.

2. The roof tarp of claim 1, further comprising:
a grommet, wherein the grommet is attached to the tarp at each corner of the tarp; and
a lifting means attached to the grommet.

3. The roof tarp of claim 2, wherein the lifting means is a rope.

4. The roof tarp of claim 3, wherein the strip is made of tar.

5. The roof tarp of claim 4, wherein the covering is made of cellophane.

6. The roof tarp of claim 4, wherein the covering is made of a paper backing material.

7. The roof tarp of claim 1, wherein the strip is made of self-adhering membranes.

8. The roof tarp of claim 7, wherein the covering is made of cellophane.

9. The roof tarp of claim 7, wherein the covering is made of a paper backing material.

10. The roof tarp of claim 1, wherein the strip is made of tar.

11. The roof tarp of claim 10, wherein the covering is made of cellophane.

12. The roof tarp of claim 10, wherein the covering is made of a paper backing material.

13. (canceled)

14. (canceled)

15. (canceled)

16. A method of using the roof tarp of claim 3, comprising the steps of:
lifting the roof tarp on to a damaged roof;
placing the first face of the roof tarp over the damaged roof;
removing the covering from the strip; and
applying pressure to the second face of the tarp at a location immediately above the strip so that the strip adheres to the roof.

17. A method of using the roof tarp of claim 3, comprising the steps of:
lilting two tarps on to a damaged roof;
aligning the first face of the first tarp with the second face of the second tarp so that the edge of the second tarp overlaps the first tarp, the tarps being linearly aligned;
removing the covering from the second tarp;
applying pressure to the second tarp so that the fist and the second tarps are attached together,
then placing the first faces of the tarps over the damaged roof;
removing the coverings from the strips; and
applying pressure to the second face of the tarps at locations immediately above the strips so that the strips adhere to the roof.
